(19) United States
(12) Patent Application Publication
(10) Pub. No.: US 2008/0061625 A1
(43) Pub. Date: Mar. 13, 2008

(54) VEHICLE STABILITY CONTROL SYSTEM FOR LOW TIRE PRESSURE SITUATIONS

(75) Inventors: Paul Schmitt, Ypsilanti, MI (US); Todd Brown, Dearborn, MI (US); Jerry Engelman, Plymouth, MI (US); Keith Mattson, Livonia, MI (US); Aaron Mills, Ann Arbor, MI (US); Albert Salib, Superior Twp., MI (US); Michael Brewer, Royal Oak, MI (US); Fred Owens, Dearborn, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/470,869

(22) Filed: Sep. 7, 2006

(51) Int. Cl. B60T 8/60

(52) U.S. Cl. 303/146

(57) ABSTRACT

A control system (10) for a vehicle (16) includes a sensor (228-240) that generates a sensor signal and a stability control system (14). A tire pressure monitoring system (12) generates a tire pressure signal. A brake (262) is coupled to the stability control system (14) and is associated with a rotational object (212) of the vehicle (16). A controller (18, 226) is coupled to the sensor (228-240), has multiple tire pressure associated brake control ranges R₁-R₃, and detects an unstable event in response to the sensor signal. The controller (18, 226) also applies a brake pressure in response to the tire pressure signal and the tire pressure associated brake control ranges R₁-R₃ via the stability control system (14).

### TECHNICAL FIELD

The present invention relates generally to vehicle stability control systems and tire pressure monitoring systems. More particularly, the present invention is related to the detection and accounting for low tire pressures during an active stability control event.

### BACKGROUND

Several stability control systems currently exist. Example stability control systems are electronic stability control systems (ESC), yaw stability control systems (YSC), and roll stability control systems (RSC). The stability control systems are utilized to maintain controlled and stable vehicle operations for improved vehicle and occupant safety. The stability control systems are often used to maintain vehicle tractions and to prevent or mitigate a roll over event.

One common aspect of a stability control system is to monitor and control the brake fluid pressures within a brake system. When, for example, an unstable event or a roll over event is detected, typical state-of-the-art RSC interventions may occur. Such interventions require aggressive or sharp increases in brake fluid pressure to quickly brake one or more tires. The braking counteracts the forces experienced during such an event, thereby, stabilizing the vehicle.

When tire pressure is low, the large increases in tire pressure due to RSC system interventions can lead to tire-debeading. The term “tire-debeading” refers to the separation of the bead wire from a tire and thus the breakdown of that tire. Debeading of a tire can result in rim or wheel contact with a road surface. Since wheels have substantially lower longitudinal and unpredictable lateral force capability, wheel and road contact can lead to vehicle instability.

Thus, there exists a need for an improved stability control system that accounts for low tire pressure situations.

### SUMMARY OF THE INVENTION

One embodiment of the present invention provides a control system for a vehicle that includes a sensor that generates a sensor signal and a stability control system. A tire pressure monitoring system generates a tire pressure signal. A brake is coupled to the stability control system and is associated with a rotational object of the vehicle. A controller is coupled to the sensor, has multiple tire pressure associated brake control ranges, and detects an unstable event in response to the sensor signal. The controller also applies a brake pressure in response to the tire pressure signal and the tire pressure associated brake control ranges via the stability control system.

Another embodiment of the present invention provides a method of operating a control system of a vehicle. The method includes the generating of a sensor signal and a tire pressure signal. An unstable event is detected in response to the sensor signal. A limited brake pressure is applied in response to the tire pressure signal and multiple tire pressure associated brake control ranges via a stability control system.

The embodiments of the present invention provide several advantages. One advantage provided by an embodiment of the present invention is a stability control system that is capable of obtaining tire pressure knowledge and adjusting stability control functions accordingly.

Another advantage provided by an embodiment of the present invention is a stability control system that reduces the amount of brake pressure applied according to measured tire pressure and to prevent tire-debeading.

Yet another advantage provided by another embodiment of the present invention is a control system that allows for quicker or earlier and softer stability control interventions at low slip levels. This further prevents tire-debeading.

The present invention itself, together with further objects and attendant advantages, will be best understood by reference to the following detailed description, taken in conjunction with the accompanying drawing.

### BRIEF DESCRIPTION OF THE DRAWINGS

For a more complete understanding of this invention reference should now be had to the embodiments illustrated in greater detail in the accompanying figures and described below by way of examples of the invention wherein:

FIG. 1 is a block diagrammatic view of a control system, including a tire pressure monitoring system and a stability control system, for a vehicle in accordance with an embodiment of the present invention;

FIG. 2 is a block diagrammatic view of a tire pressure monitoring system in accordance with an embodiment of the present invention;

FIG. 3 is a block diagrammatic view of a pressure transmitter in accordance with an embodiment of the present invention;

FIG. 4 is a block diagrammatic view of a stability control system in accordance with an embodiment of the present invention;

FIG. 5 is a block diagrammatic view illustrating interrelationships among various units within a control system for controlled vehicle dynamics in accordance with an embodiment of the present invention;

FIG. 6 is a logic flow diagram illustrating a method of operating a control system or a stability control system of a vehicle in accordance with an embodiment of the present invention; and

FIG. 7 is an allowable brake pressure versus tire pressure plot in accordance with an embodiment of the present invention.

### DETAILED DESCRIPTION

In the following figures the same reference numerals will be used to identify the same components. The present invention may be used in conjunction with vehicle control systems including a yaw stability control (YSC) systems, roll stability control (RSC) systems, lateral stability control (LSC) systems, integrated stability control (ISC) systems, or a total vehicle control system for achieving fuel economy and safety and other vehicle level performances. The present invention is also described with respect to an integrated sensing system (ISS), which uses a centralized motion sensor cluster such as an inertial measurement unit (IMU) and other available, but decentralized, sensors. Although a centralized motion sensor, such as an IMU, is primarily described, the techniques described herein are easily transferable to using the other discrete sensors.

Also, a variety of other embodiments are contemplated having different combinations of the below described features of the present invention, having features other than those described herein, or even lacking one or more of those features. As such, it is understood that the invention can be carried out in various other suitable modes.

In the following description, various operating parameters and components are described for one constructed embodiment. These specific parameters and components are included as examples and are not meant to be limiting.

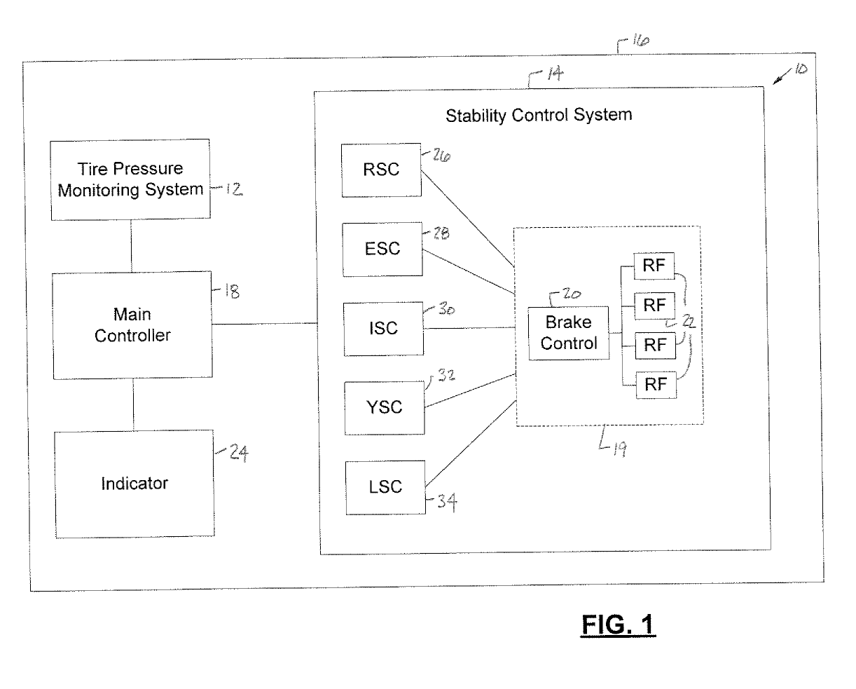

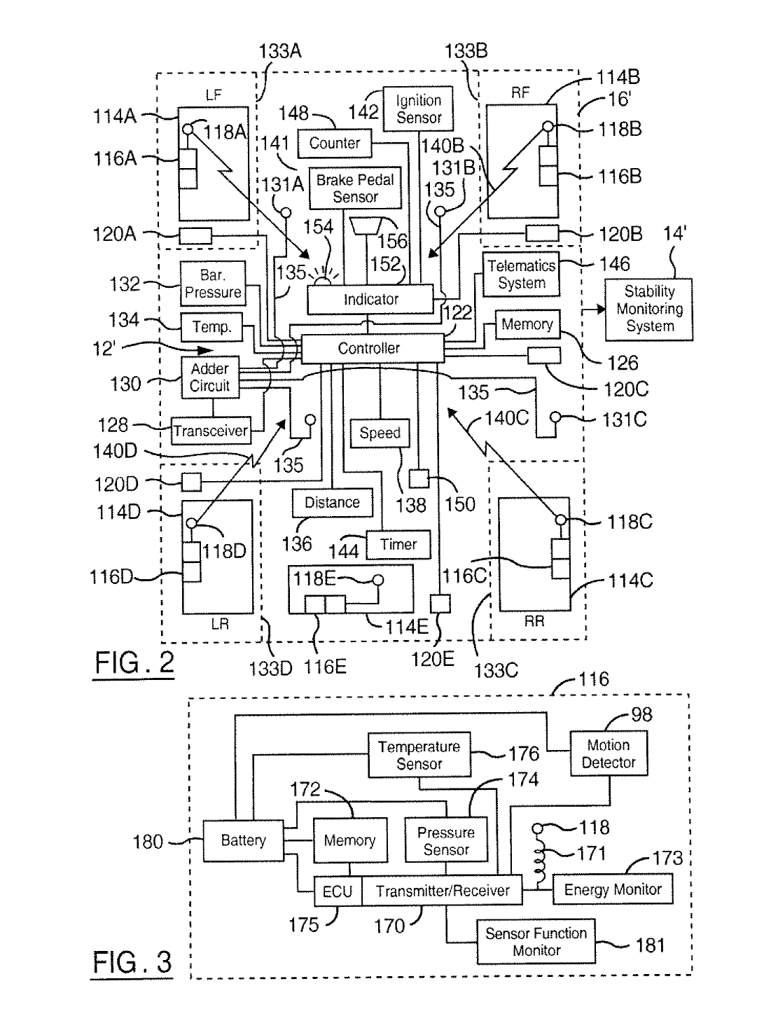

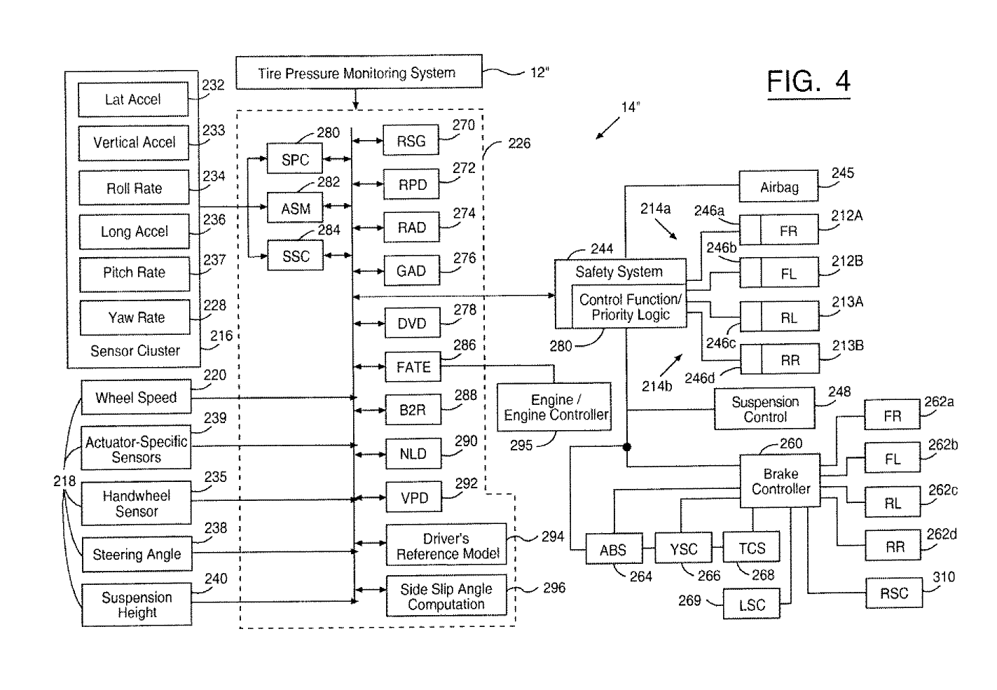

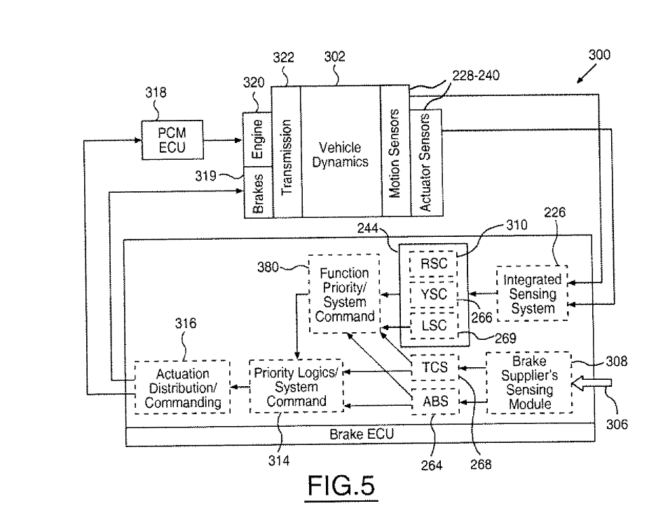

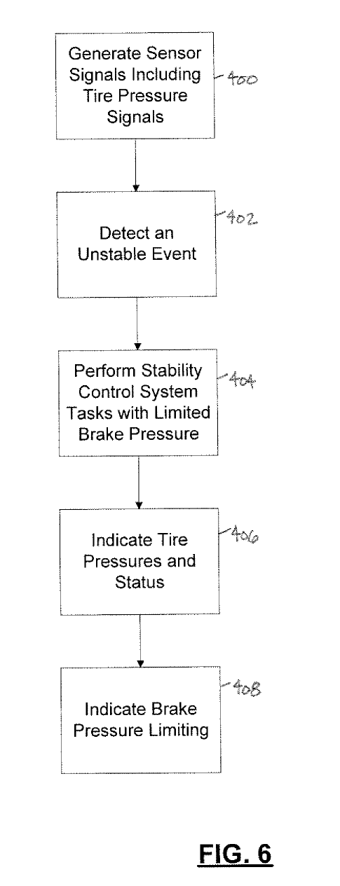

Referring now to FIG. 1, a block diagrammatic view of a control system 10, including a tire pressure monitoring system 12 and a stability control system 14, for a vehicle 16 in accordance with an embodiment of the present invention is shown. The control system 10 utilizes tire pressure status information gathered from the tire pressure monitoring system 12 in operation of the stability control system 14. A sample tire pressure monitoring system is described in detail with respect to FIGS. 2 and 3. A sample stability control system is described with respect to FIGS. 4 and 5. The control system 10 includes one or more controllers 18 (only one is shown in FIG. 1). The controllers 18 may be part of the tire pressure monitoring system 12, the stability control system 14, or may be a stand-alone controller, as shown. The stability control system 14 is coupled to a braking circuit 19, which includes a brake control 20 that is used to actuate brakes 22. The stability control system 14 in response to the tire pressure information may adjust actuation of the brakes accordingly. This is described in greater detail below, especially in respect to the method of FIG. 6. The tire pressure information may be indicated to a vehicle occupant via the indicator 24. The stability control system 14 may be or include a RSC system 26, an ESC system 28, an ISC system 30, a YSC system 32, a LSC system 34, or some other stability control system known in the art.

The controllers is may be microprocessor based such as a computer having a central processing unit, memory (RAM and/or ROM), and associated input and output buses. The controllers may be application-specific integrated circuits or may be formed of other logic devices known in the art. The controllers may each be a portion of a central vehicle main control unit, an interactive vehicle dynamics module, a restraints control module, a main safety controller, a control circuit having a power supply, combined into a single integrated controller, or may be a stand-alone controller as shown.

The indicator 24 may include a video system, an audio system, a heads-up display, a flat-panel display, a telematic system, a dashboard indicator, a panel indicator, or other indicator known in the art. In one embodiment of the present invention, the indicator 24 is in the form of a heads-up display and the indication signal is a virtual image projected to appear forward of the vehicle 16. The indicator 24 provides a real-time image of the target area to increase the visibility of the objects during relatively low visible light level conditions without having to refocus ones eyes to monitor an indication device within the vehicle 16.

Referring now to FIG. 2, a block diagrammatic view of a tire pressure monitoring system 12′ for a vehicle 16′ in accordance with an embodiment of the present invention is shown. The pressure monitoring system 12′ monitors the air pressure within a left front tire 114a, a right front tire 114b, a right rear tire 114c, and a left rear tire 114d. Each tire 114a-114d has a respective tire pressure sensor circuit 116a, 116b, 116c, and 116d, each of which has a respective antenna 118a, 118b, 118c, and 118d. Each tire 114a-114d is positioned upon a corresponding wheel.

A fifth tire or spare tire 114e is also illustrated having a tire pressure sensor circuit 116e and a respective antenna 116e. Although five wheels are illustrated, the pressure of various numbers of wheels may be increased. For example, the present invention applies equally to vehicles such as pickup trucks that have dual wheels for each rear wheel. Also, various numbers of wheels may be used in a heavy duty truck application having dual wheels at a number of locations. Further, the present invention is also applicable to trailers and extra spares.

Each tire 114 may have a respective initiator 120a-120e positioned within the wheel wells adjacent to the tire 114. Initiator 120 generates a low frequency RF signal initiator and is used to initiate a response from each wheel so that the position of each wheel may be recognized automatically by the pressure monitoring system 12′. Initiators 120a-120e are coupled directly to a controller 122. In commercial embodiments where the position programming is done manually, the initiators may be eliminated.

Controller 122 may be microprocessor based controller having a programmable CPU that may be programmed to perform various functions and processes including those set forth herein. Controller 122 has a memory 126 associated therewith. Memory 126 may be various types of memory including ROM or RAM. Memory 126 is illustrated as a separate component. However, those skilled in the art will recognize controller 122 may have memory 126 therein. The memory 126 is used to store various thresholds, calibrations, tire characteristics, wheel characteristics, serial numbers, conversion factors, temperature probes, spare tire operating parameters, and other values needed in the calculation, calibration and operation of the pressure monitoring system 12. For example, memory may contain a table that includes the sensor identification thereof. Also, the warning statuses of each of the tires may also be stored within the table.

Controller 122 is also coupled to a transceiver 128. Although the transceiver 128 is illustrated as a separate component, the transceiver 123 may also be included within controller 122. The transceiver 128 has an antenna 130 associated therewith. The antenna 130 is used to receive pressure and various information from tire pressure circuits 116a-116e. The controller 122 is also coupled to a plurality of sensors. Such sensors may include a barometric pressure sensor 132, an ambient temperature sensor 134, a distance sensor 136, a speed sensor 138, a brake pedal sensor 140, and an ignition sensor 142. Of course, various other types of sensors may be used. Barometric pressure sensor 132 generates a barometric pressure signal corresponding to the ambient barometric pressure. The barometric pressure may be measured directly, calculated, or inferred from various sensor outputs. The barometric pressure compensation may be used, but is not required in the calculation for determining the pressure within each tire 114. Temperature sensor 134 generates an ambient temperature signal corresponding to the ambient temperature and may be used to generate a temperature profile.

Distance sensor 136 may be one of a variety of sensors or combinations of sensors to determine the distance traveled for the automotive vehicle. The distance traveled may merely be obtained from another vehicle system either directly or by monitoring the velocity together with a timer 144 to obtain a rough idea of distance traveled. Speed sensor 138 may be a variety of speed sensing sources commonly used in automotive vehicles such as a two wheel used in anti-lock braking systems, or a transmission sensor.

Timer 144 may also be used to measure various times associated with the process set forth herein. The timer 144, for example, may measure the time the spare tire is stowed, or measure a time after an initiator signal.

Brake pedal sensor 141 may generate a brake-on or brake-off signal indicating that the brake pedal is being depressed or not depressed, respectively. Brake pedal sensor 141 may be useful in various applications such as the programming or calibrating of the pressure monitoring system 12′.

Ignition sensor 142 may be one of a variety of types of sensors to determine if the ignition is powered on. When the ignition is on, a run signal may be generated. When the ignition is off, an off signal is generated. A simple ignition switch may act as an ignition sensor 142. Of course, sensing the voltage on a particular control line may also provide an indication of whether the ignition is activated. The pressure monitoring system 12′ may not be powered when the ignition is off. However, in one constructed embodiment, the system receives information about once an hour after the ignition has been turned off.

A telemetric system 146 may be used to communicate various information to and from a central location from a vehicle. For example, the control location may keep track of service intervals and use and inform the vehicle operator service is required.

A counter 148 may also be included in control system 12′. Counter 148 may count, for example, the number of times a particular action is performed. For example, counter 148 may be used to count the number of key-off to key-on transitions of course, the counting function may be inherent in controller 122.

The controller 122 is in communication with a stability monitoring system 14′, which is similar to the stability monitoring system 14. The controller 122 may communicate using wired or wireless connections. The controller 122 may communicate to the stability control system 14′ via the transceiver 128, the telematics system 146, or via some other communication link. Note that the stability monitoring system 14′ may also receive tire pressure information directly from the tire circuits 116 and the antennas 118.

Controller 122 may also be coupled to a button 150 or plurality of buttons 150 for inputting various information, resetting the controller 122, or various other functions as will be evident to those skilled in the art through the following description.

Controller 122 may also be coupled to an indicator 152. Indicator 152 is similar to the indicator 24 and may include an indicator light or display panel 154, which generates a visual signal, or an audible device 156 such as a speaker or buzzer that generates an audible signal. Indicator 152 may provide some indication as to the operability of the system such as confirming receipt of a signal such as a calibration signal or other commands, warnings, and controls as will be further described below. Indicator may be an LED or LCD panel used to provide commands to the vehicle operator when manual calibrations are performed.

Referring now also to FIG. 3, a block diagrammatic view of a pressure transmitter in accordance with an embodiment of the present invention is shown. A tire pressure sensor circuit 116 is illustrated. Pressure monitoring system 12′ has a transmitter/receiver or transceiver 170. The transmitter/receiver 170 is coupled to antenna 118 for transmitting various information to receiver 128. The transmitter/receiver 170 may be used to receive an activation signal for an initiator located at each wheel. The sensor circuit 116 may have various information such as a serial number memory 172, a pressure sensor 174 for determining the pressure within the tire, a temperature sensor 176 for determining the temperature within the tire, and a motion detector 178 which may be used to activate the system pressure sensing system. The initial message is referred to as a “wake” message, meaning the pressure sensing circuit is now activated to send its pressure transmissions and the other data,

Each of the transceiver 170, serial number memory 172, pressure sensor 174, temperature sensor 176, and motion sensor 178 are coupled to the battery 180. The battery 180 may be a long-life battery capable of lasting through the life of the tires.

A sensor function monitor 181 may also be incorporated into tire pressure sensor circuit 116. The sensor function monitor 181 generates an error signal when various portions of the tire pressure circuit are not operating or are operating incorrectly. Also, sensor function monitor may generate a signal indicating that the circuit 116 is operating normally.

Referring to FIG. 4, a block diagrammatic view of a stability control system 14′ in accordance with an embodiment of the present invention is shown. The stability control system 14′ may be part of a vehicle dynamics control or an active safety system. The stability control system 14′ may monitor the forces and moments exerted or experienced. Front right (FR) and front left (FL) wheel/tires 212A and 212B and rear right (RR) wheel/tires 213A and rear left (RL) wheel/tires 213B, respectively, are shown and may be part of a vehicle, such as the vehicle 16. The vehicle may also have a number of different types of front steering systems 214a and rear steering systems 214b, including having each of the front and rear wheels configured with a respective controllable actuator, the front and rear wheels having a conventional type system in which both of the front wheels are controlled together and both of the rear wheels are controlled together, or a system having conventional front steering and independently controllable rear steering for each of the wheels or vice versa.

As mentioned above, the system may also be used with other vehicle dynamics controls, such as ride and handling control systems including active/semi-active suspension systems, anti-roll bar, or the other safety systems, such as airbags or passive safety devices deployed or activated upon sensing predetermined dynamic conditions of a vehicle.

The stability monitoring system 14′ includes the controller or integrated sensing system (ISS) 226, which signals the safety system 244, the suspension control 248, and the brake control 260 in response to information received from a tire pressure monitoring system 12″, the sensor cluster 216 and various other sensors 218.

The ISS unit 226 may comprise many different sensors as will be described further below. The sensors may also be used by the ISC unit 244 in various determinations, such as to determine a wheel lifting event like an imminent rollover, determine various forces including normal forces at the wheels, determine a height and position of a mass, determine the instability trend of the unstable dynamics as in unstable roll or yaw motions, determine the intentions of a driver, determine the feedforward control commands to drive actuators, determine feedback control commands for the desired functions, and the like. The wheel speed sensors 220 are mounted at each corner of the vehicle and generate signals corresponding to the rotational speed of each wheel of the vehicle. The rest of the sensors used in the ISS unit 226 may include the other decentralized sensors and a centralized motion sensor such as an IMU or a RSC sensor cluster mounted directly on a rigid surface of the vehicle body such as the vehicle floor or the chassis frame,

The ISS unit 226 is used to receive information in the form of associated signals from a number of sensors which may include sensors within the sensor cluster 216, such as the yaw rate sensor 228, the lateral acceleration sensor 232, the vertical acceleration sensor 233, the roll angular rate sensor 234, the hand wheel sensor 235 (steering wheel within the vehicle), the longitudinal acceleration sensor 236, and the pitch rate sensor 237, and other sensors, such as the speed sensor 220, the steering angle (of the wheels or actuator) position sensor 238 (steered wheel angle), the actuator-specific sensors 239, and the suspension position (height) sensor 240. It should be noted that various combinations and sub-combinations of the sensors may be used.

Based upon inputs from the sensors, the ISS unit 226 may feed information to the ISC unit 244 that further drives the actions of the available actuators. Depending on the desired sensitivity of the system and various other factors, not all the sensors may be used in a commercial embodiment. The ISC unit 244 may control an airbag 245 or a steering actuator 246A-246D at one or more of the wheels 212A, 212B, 213A, 213B of the vehicle. Also, other vehicle subsystems such as a suspension control 248 may be used for ride, handling and stability purposes.

The roll angular rate sensor 234 and the pitch rate sensor 237 may be replaced by sensors that sense the height of one or more points on the vehicle relative to the road surface to, thereby, sense the roll condition or lifting of the vehicle. The sensors that may be used to achieve this may include but are not limited to a radar-based proximity sensor, a laser-based proximity sensor and a sonar-based proximity sensor. The roll rate sensor 234 may also be replaced by a combination of sensors such as the proximity sensors to make a roll determination.

The roll rate sensor 234 and the pitch rate sensor 237 may also be replaced by sensors sensing the linear or rotational relative displacement or displacement velocity of one or more of the suspension chassis components to sense the roll condition or lifting of the vehicle. This may be in addition to or in combination with the suspension distance sensor 240, The suspension distance sensor 240 may be a linear height or travel sensor and a rotary height or travel sensor.

The yaw rate sensor 228, the roll rate sensor 234, the lateral acceleration sensor 232, and the longitudinal acceleration sensor 236 may be used together to determine that a single wheel or that two wheels of a vehicle are lifted and the quantitative information regarding the relative roll information between the vehicle body and the moving road plane. Such sensors may also be used to determine normal loading associated with wheel lift.

The roll condition such as the relative roll angle of the vehicle body with respect to the road surface or with respect to the sea level may also be established by one or more of the following translational or rotational positions, velocities or accelerations of the vehicle including the roll rate sensor 234, the yaw rate sensor 228, the lateral acceleration sensor 232, the vertical acceleration sensor 233, a vehicle longitudinal acceleration sensor 236, lateral or vertical speed sensor including a wheel-based speed sensor 220 or other radar, sonar, laser, or optical based speed sensors.

The ISS unit 226 may include sensing algorithms including but not limited to reference attitude and reference directional velocity determinations, global/relative attitude determination, directional velocity determination, sensor plausibility check, sensor signal conditioning, road parameter determination, and abnormal state monitoring.

The ISS unit 226 includes various control units controlling the aforementioned sensing algorithms. More specifically, these units may include: a reference signal unit 270 (reference signal generator (RSG)), which includes an attitude reference computation and a velocity reference computation, a road profile unit 272 (road profile determination unit (RPD)), an attitude unit or relative attitude determination unit 274 (RAD), a global attitude unit 276 (global attitude determination unit (GAD) and a directional velocity unit 278 (directional velocity determination unit (DVD)), a sensor plausibility unit 80 (sensor plausibility check unit (SPC)), an abnormal state unit 282 (abnormal state monitoring unit (ASM)), a sensor signal compensating unit 284 (SSC), an estimation unit 286 (force and torque estimation unit (FATE)), a car body to fixed reference frame unit 288 (body to reference unit (B2R)), a normal loading unit 290 (normal loading determination unit (NLD)), a vehicle parameter unit 292 (vehicle parameter determination unit (VPD)), a four wheel driver reference model 294 and a sideslip angle computation 296. The estimation unit is coupled to an engine controller 295. Signals generated from any one of the aforementioned units are referred to prediction of vehicle operation states signals.

The ISC unit 244 may control the position of the front right wheel actuator 246A, the front left wheel actuator 246B, the rear left wheel actuator 246C, and the right rear wheel actuator 246D. Although as described above, two or more of the actuators may be simultaneously controlled. For example, in a rack-and-pinion system, the two wheels coupled thereto are simultaneously controlled. Based on the inputs from sensors 228 through 240 and from the tire pressure monitoring system 12, 1, the ISS unit 226 determines a roll condition and/or wheel lift and controls the steering position and/or braking of the wheels.

The ISC unit 244 may be coupled to a brake controller 260. Brake controller 260 controls the amount of brake torque at a front right brake 262a, front left brake 262b, rear left brake 262c and a rear right brake 262d. The functions performed through the ISC 244 may include a RSC function 310, a YSC function 266, and a LSC function 269. The other functional units such as an anti-lock-braking system (ABS) unit 264 and a traction control system (TCS) unit 265 may be provided. Those functions might be improved through utilizing the signals calculated in the ISS unit 226.

Speed sensor 220 may be one of a variety of speed sensors known to those skilled in the art. For example, a suitable speed sensor may include a sensor at every wheel that is averaged by the ISS unit 226. The algorithms used in ISS may translate the wheel speeds into the travel speed of the vehicle. Yaw rate, steering angle, wheel speed, and possibly a slip angle estimate at each wheel may be translated back to the speed of the vehicle at the center of gravity. Various other algorithms are known to those skilled in the art. Speed may also be obtained from a transmission sensor. For example, if speed is determined while speeding up or braking around a corner, the lowest or highest wheel speed may not be used because of its error. Also, a transmission sensor may be used to determine vehicle speed instead of using wheel speed sensors.

Although the above discussions are valid for general stability controls, some specific considerations of using them in RSC will be discussed. The roll condition of a vehicle during an imminent rollover may be characterized by the relative roll angle between the vehicle body and the wheel axle and the wheel departure angle (between the wheel axle and the average road surface). Both the relative roll angle and the wheel departure angle may be calculated in relative roll angle estimation module (RAD) 274 by using the roll rate, lateral acceleration sensor signals and the other available sensor signals used in the ISS unit 226. If both the relative roll angle and the wheel departure angles are large enough, the vehicle may be in either single wheel lifting or double wheel lifting. On the other hand, if the magnitude of both angles is small enough, the wheels are likely all grounded; therefore the vehicle is not rolling over. In case that both of them are not small and the double wheel lifting condition is detected or determined (see for example U.S. Pat. No. 6,904,350), the sum of those two angles will be used to compute the feedback commands for the desired actuators so as to achieve rollover prevention. The variables used for this purpose might be included in the ISS unit 226.

The roll information of a vehicle during an imminent rollover may be characterized by rolling radius-based wheel departure roll angle, which captures the angle between the wheel axle and the average road surface through the dynamic rolling radii of the left and right wheels when both of the wheels are grounded. Since the computation of the rolling radius is related to the wheel speed and the linear velocity of the wheel, such rolling-radius based wheel departure angle will assume abnormal values when there are large wheel slips. This happens when a wheel is lifted and there is torque applied to the wheel. Therefore, if this rolling radius-based wheel departure angle is increasing rapidly, the vehicle might have lifted wheels. Small magnitude of this angle indicates the wheels are all grounded. The variables used for this purpose might be included in the ISS unit.

The roll condition of the vehicle during an imminent rollover may be seen indirectly from the wheel longitudinal slip. If during a normal braking or driving torque the wheels at one side of the vehicle experience increased magnitude of slip, then the wheels of that side are losing longitudinal road torque. This implies that the wheels are either driven on a low mu surface or lifted up. The low mu surface condition and wheel-lifted-up condition may be further differentiated based on the chassis roll angle computation, i.e., in low mu surface, the chassis roll angle is usually very small. The variables used for this purpose might be included in the ISS unit.

The roll condition of the vehicle during an imminent rollover may be characterized by the normal loading sustained at each wheel. Theoretically, when a normal loading at a wheel decreases to zero, the wheel is no longer contacting the road surface. In this case a potential rollover is underway. Large magnitude of this loading indicates that the wheel is grounded. Normal loading is a function of the calculated chassis roll and pitch angles. The variables used for this purpose might be included in the ISS unit.

The roll condition of a vehicle during imminent rollover may be identified by checking the actual road torques applied to the wheels and the road torques, which are needed to sustain the wheels when they are grounded. The actual road torques may be obtained through torque balancing for each wheel using wheel acceleration, driving torque and braking torque. If the wheel is contacting the road surface, the calculated actual road torques must match or be larger than the torques determined from the nonlinear torques calculated from the normal loading and the longitudinal slip at each wheel. The variables used for this purpose might be included in the ISS unit.

The roll condition of a vehicle during an imminent rollover may be characterized by the chassis roll angle itself, i.e., the relative roll angle between the vehicle body and the wheel axle. If this chassis roll angle is increasing rapidly, the vehicle might be on the edge of wheel lifting or rollover. Small magnitude of this angle indicates the wheels are not lifted or are all grounded. Therefore, an accurate determination of the chassis roll angle is beneficial for determining if the vehicle is in non-rollover events and such computation is conducted in the RAD unit 274 and in the ISS 226.

The roll condition of a vehicle during imminent rollover may also be characterized by the roll angle between the wheel axle and the average road surface, which is called a wheel departure angle (WDA). If the roll angle is increasing rapidly, the vehicle has lifted wheel or wheels and aggressive control action needs to be taken in order to prevent the vehicle from rolling over. Small magnitude of this angle indicates the wheels are not lifted. The variables used for this purpose might be included in the ISS unit 226.

The ISC unit 244 may include control function logic and control function priority logic. As illustrated, the logic resides within ISC unit 244, but may be part of the ISS unit 226 and/or brake controller 260.

Referring now to FIG. 5, a block diagrammatic view illustrating interrelationships among various units within a control system 300 for controlled vehicle dynamics in accordance with an embodiment of the present invention is shown. The vehicle dynamics is represented by the module 302. The vehicle dynamics 302 includes the angular and translation movements of a vehicle. The motion and actuation sensors 228-240 generate signals corresponding to the vehicle dynamics and the actions of the various actuators. The sensors are fed into the ISS unit 226. The sensor signals and the calculated signals from a system other than ISS (for example, the brake supplier's own brake control computations) 306 may be fed into to sensing module 308. The ISS unit 226 is coupled to the ISCS unit 244 and may specifically be coupled to the RSC function module 310 and the YSC function module 266. A function priority system command 380 may also be included. The output of the TCS module 268 and the ABS module 264 may be coupled to priority logic system command 314, which in turn is coupled to the actuation distribution and commanding block 316. The actuation distribution commanding block 316 is coupled to the powertrain control ECU 318 and to the brakes 319. The powertrain control module 318 may be coupled to the engine 320 and transmission 322. The actuation of the engine, the brakes and the transmission may affect the vehicle dynamics 302, which in turn is sensed by the various sensors. Thus, as can be seen, a continuous loop of sensing and controlling with respect to the vehicle dynamics is illustrated.

Referring now to FIG. 6, a logic flow diagram illustrating a method of operating a control system or a stability control system of a vehicle in accordance with an embodiment of the present invention is shown,

In step 400, various sensor signals are generated from sensors, such as those described herein above. In particular, tire pressure signals are generated, which are indicative of the current tire pressure within each tire of the vehicle. The thresholds that are used in activating or initiating interventions as performed in step 404 may be adjusted, scaled, opened, or relaxed, depending upon the tire pressures and/or the level of tire debeading risk, to alter intervention timing. For example, for lower tire pressures earlier interventions may be desired

In step 402, the control system in response to the sensor signals detects an unstable event or a potential roll over event for a current moment in time. The current status and conditions of the vehicle are such that a roll over event may occur should the vehicle not be stabilized

In step 404, the control system performs stability control system tasks in response to the detected unstable event The control system, based on the tire pressure information and the other sensor information intervenes in stability control operations when appropriate to limit systematically applied brake pressure. The control system limits the brake pressure applied to the appropriate wheels of the vehicle, by a stability control system, to stabilize the vehicle and to prevent a roll over. The amount that the brake pressure is limited by is determined based on the current tire pressures.

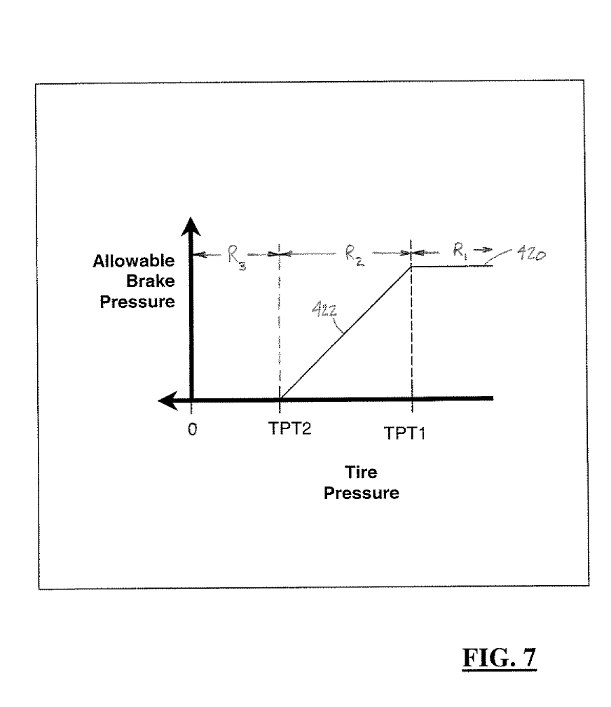

Referring now to FIG. 7, an allowable brake pressure versus tire pressure plot is shown. The brake/tire plot has a brake/tire pressure curve 420 and illustrates three ranges: a full range or maximum tire pressure range R₁, a reduced range or brake pressure limiting range R₂, and a inactive range or brake pressure prevented range R₃. When the tire pressure of a tire of concern is in the first range or greater than or equal to a first tire pressure threshold value TPT1, the control system may apply a brake pressure up to a maximum threshold. In the full range brake control functions are maintained. Note that the full range may have an upper maximum brake pressure limit (not shown). When the tire pressure of a tire of concern is in the reduced range or between the first tire threshold TPT1 and the second tire threshold TPT2, the control system may apply a reduced or limited brake pressure, which is less than that which would normally be applied if the tire pressure were greater than the first tire threshold TPT1. In the reduced range the amount that the brake pressure is limited is gradually or progressively increased. This increase may be linear, as shown, may be non-linear, or may result using some other relationship. In FIG. 7 the brake/tire pressure curve includes a ramp 422 in the reduced pressure range R₂. When the tire pressure of a tire of concern is less than or equal to the second tire threshold TPT2, the control system is prevented from applying brake pressure. Although the control system is prevented from applying a brake pressure, brake pressure may be applied manually by a vehicle operator. In another embodiment, the control system overrides the manual brakes and limits or prevents manual brake pressure.

The brake pressure limitation function may be derived using tire-debeading information. The debeading information may be tire specific or may include a safety factor to account for various tires or tires in general. The tire-debeading information may also include a point or points at which tire-debeading risk increases, which may be in association with a maximum braking torque. The brake pressure limitation function may include a tire-debeading factor, which is associated with the amount that brake pressure is limited based on the tire-debeading information. For example, for a particular situation and event and tire pressure, the brake pressure to be applied may be reduced by the tire-debeading factor. The extent to which the reduction in brake pressure is less than the tire-debeading factor is related to the risk in the tire-debeading.

Of course, the brake pressure may also be limited based on the other sensor information, other than the tire pressure information. The control system may adjust the applied brake pressure, for example, when the slip level for a tire of concern is greater than a predetermined level. This may also be performed to prevent tire debeading. The brake pressure intervention may occur at lower than normal slip levels to provide earlier reduction in unstable vehicle characteristics, such as yaw rate or lateral yaw oscillations.

Note that although brake pressure may be limited to one or more wheels having low tire pressures, brake pressure may not be limited to wheels that have tires with adequate tire pressures.

In step 406, the control system may indicate via an indicator, such as the indicator, to a vehicle operator the pressure of the tires and/or the status of each tire. The control system may indicate that a tire pressure is low and the extent thereof. This information may also be stored, viewed, and downloaded for future review and/or evaluation. The viewing and downloading may be to an offboard or offsite system.

In one example situation and during a particular dynamic maneuver that requires stability control, a tire may be on the “outside” or “inside” of a turn, If the outside front tire has low pressure, control parameters may be adjusted such that the control entry criteria is lowered and the control gains are reduced to yield early and smooth control. If the outside rear tire has low pressure, the sideslip control thresholds are tighten, to allow less destabilizing sideslip. The control system should rely on less braking but more aggressive powertrain deceleration to reduce the speed without yielding potential oversteer.

In another example situation and control event for a vehicle having properly inflated outside tires, but one or more under-inflated inside tires, the stability control interventions are not adjusted to prevent debeading. However, reference velocity calculations associated with the inside tires are scaled with tire pressure. As tire pressure decreases, the effective rolling radius decreases. Therefore, for a given speed, the wheel and tire rotates faster.

During transitional maneuvers, inside tires can quickly become outside tires and vice versa. Therefore, if the transition is aggressive, yielding sideslip, a low-pressure tire on the inside of a turn can soon become an outside tire at risk of debeading. Transition maneuvers can be identified in advance using sensed steering, yaw rate, roll rate, lateral acceleration, and wheel speed information. Once identified, tighter sideslip control thresholds can be set to allow less destabilizing sideslip.

In step 408, the control system may also indicate when brake controlled tire pressure is being limited due to tire pressure or some other variable.

The above tasks may be performed via any one or more of the herein mentioned controllers, control systems, stability control systems, or the like.

The above-described steps are meant to be illustrative examples; the steps may be performed sequentially, synchronously, simultaneously, or in a different order depending upon the application.

While particular embodiments of the invention have been shown and described, numerous variations and alternate embodiments will occur to those skilled in the art. Accordingly, it is intended that the invention be limited only in terms of the appended claims.

What is claimed is:

1. A control system for a vehicle comprising:
at least one sensor generating a sensor signal;
a stability control system;
a tire pressure monitoring system generating a tire pressure signal;
at least one brake coupled to said stability control system and associated with a rotational object of the vehicle; and
a controller coupled to said at least one sensor, having a plurality of tire pressure associated brake control ranges, detecting an unstable event in response to said sensor signal, and applying a brake pressure in response to said tire pressure signal and said plurality of tire pressure associated brake control ranges via said stability control system.

2. A system as in claim 1 wherein said controller in applying said brake pressure applies a reduced brake pressure that is less than a predetermined brake pressure associated with said unstable event for a current moment in time.

3. A system as in claim 2 wherein said controller determines said reduced brake pressure based on tire debeading information.

4. A system as in claim 1 wherein said controller limits said applied brake pressure by a tire-debeading factor.

5. A system as in claim 1 wherein said plurality of tire pressure associated brake control ranges comprises:
a full brake control range;
a reduced brake control range; and
an inactive brake control range.

6. A system as in claim 1 wherein said controller maintains full brake control functions when said tire pressure signal is greater than a threshold.

7. A system as in claim 1 wherein said controller progressively reduces said applied brake pressure, than that normally applied during said unstable event, when said tire pressure signal is within upper and lower bounds of a tire pressure range.

8. A system as in claim 1 wherein said controller ceases to apply said brake pressure when said tire pressure signal is less than a threshold.

9. A system as in claim 8 further comprising an indicator, said controller indicating prevention of a brake control function.

10. A system as in claim 1 wherein said controller determines a slip level of at least one wheel of the vehicle and in response thereto adjusts said applied brake pressure.

11. A system as in claim 10 wherein said controller adjusts said applied brake pressure when said slip level is greater than a predetermined level to prevent tire-debeading.

12. A system as in claim 1 wherein said controller detects a roll over condition in response to said at least one sensor signal and applies said limited brake pressure in response thereto.

13. A system as in claim 1 wherein said at least one sensor is selected from an acceleration sensor, a roll rate sensor, a yaw rate sensor, and a pitch rate sensor.

14. A method of operating a control system of a vehicle comprising:
generating at least one sensor signal;
generating a tire pressure signal;
detecting an unstable event in response to said sensor signal; and
applying a limited brake pressure in response to said tire pressure signal and a plurality of tire pressure associated brake control ranges via a stability control system.

15. A method as in claim 14 wherein applying a limited brake pressure comprises:
applying a predetermined brake pressure associated with said unstable event when said tire pressure signal is above a first threshold; and
reducing said applied brake pressure when said tire pressure signal is equal to or less than said first threshold by a tire-debeading factor.

16. A method as in claim 15 wherein reducing said applied brake pressure comprises linearly reducing said applied brake pressure in relation to the difference between said tire pressure signal and said first threshold.

17. A method as in claim 14 comprising deactivating systematic brake control when said tire pressure signal is less than a second threshold.

18. A control system for a vehicle comprising:
at least one sensor generating a sensor signal;
a stability control system;
a tire pressure monitoring system generating a tire pressure signal;
at least one brake coupled to said stability control system and associated with a rotational object of the vehicle; and
a controller coupled to said at least one sensor, detecting an active brake control event in response to said sensor signal, determining a brake pressure to apply in response to said active brake control event, reducing said brake pressure by a predetermined amount based on upper and lower bounds of a tire pressure range and said tire pressure signal, and applying said reduced brake pressure via said stability control system.

19. A system as in claim 18 wherein said controller progressively reduces said brake pressure as said tire pressure signal decreases between upper and lower bounds of a tire pressure range.

20. A system as in claim 18 further comprising a powertrain, said controller decreasing speed of the vehicle via said powertrain when said tire pressure signal is less than a threshold.
